(19) United States
(12) Patent Application Publication
(10) Pub. No.: US 2020/0094644 A1
(43) Pub. Date: Mar. 26, 2020

(54) SUSPENSION CONTROL SYSTEM

(71) Applicant: HONDA MOTOR CO., LTD., Tokyo (JP)

(72) Inventors: Yuya GOTO, Wako-shi (JP); Ryoma KANDA, Wako-shi (JP)

(21) Appl. No.: 16/553,580

(22) Filed: Aug. 28, 2019

(30) Foreign Application Priority Data
Sep. 26, 2018 (JP) 2018180729

(51) Int. Cl. B60G 17/016; B60G 17/019; B60G 17/06

(52) U.S. Cl. CPC B60G 17/0162; B60G 17/01908; B60G 17/06; B60G 2400/0513; B60G 2400/0512; B60G 2800/014; B60G 2400/61; B60G 2500/10; B60G 2600/18; B60G 2800/019; B60G 2400/0514

(57) ABSTRACT

In a suspension control system (20) including a variable damper (6fl, 6fr) provided between a vehicle body and each of left and rear front wheels (2fl, 2fr), a ground contact load computation unit (31) computes a front wheel target ground contact load according to a fore and aft acceleration of the vehicle body. A ground contact load distribution unit (32) computes target ground contact loads of the left and right front wheels by varying a distribution of the front wheel target ground contact load between the left front wheel and the right front wheel according to a direction and a magnitude of the fore and aft acceleration and/or a direction and a magnitude of a lateral acceleration of the vehicle body, and a damping force computation unit (33) sets a target damping force of each variable damper according to the target ground contact loads of the front wheels.

### TECHNICAL FIELD

The present invention relates to a suspension control system including variable dampers.

### BACKGROUND ART

JP2006-044523A discloses a suspension control system that controls the damping forces of variable dampers according to the fore and aft acceleration of the vehicle for the purpose of suppressing a pitching motion of the vehicle.

In this previously proposed suspension control system, the damping forces of the different variable dampers are controlled according to the fore and aft acceleration, but there is no difference between the damping forces of the dampers for the right and left front wheels, or between the damping forces of the dampers for the right and left rear wheels. Thus, no consideration is made regarding the lateral motion of the vehicle. In particular, according to this prior art, the vehicle may demonstrate an understeer or an oversteer tendency when the vehicle travels a curve while accelerating or decelerating.

### SUMMARY OF THE INVENTION

In view of such a problem of the prior art, a primary object of the present invention is to provide a suspension control system that can suppress the pitching motion of the vehicle while suppressing an understeer and an oversteer tendency during cornering.

To achieve such an object, one embodiment of the present invention provides a suspension control system (20) for a vehicle having left and right front wheels (2fl, 2fr) and left and right rear wheels (2rl, 2rr), comprising: a variable damper (6fl, 6fr, 6rl, 6rr) provided between a vehicle body and each of the left front wheel (2fl), the right front wheel (2fr), the left rear wheel (2lr) and the right rear wheel (2rr); a ground contact load computation unit (31) configured to compute a front wheel target ground contact load and a rear wheel target ground contact load according to a fore and aft acceleration of the vehicle body; a contact load distribution unit (32) configured to compute target ground contact loads of the left and right front wheels by varying a distribution of the front wheel target ground contact load between the left front wheel and the right front wheel, and to compute target ground contact loads of the left and right rear wheels by varying a distribution of the rear wheel target ground contact load between the left rear wheel and the right rear wheel, according to a direction and a magnitude of the fore and aft acceleration and/or a direction and a magnitude of a lateral acceleration of the vehicle body; and a damping force computation unit (33) configured to set a target damping force of each variable damper according to the target ground contact loads of the front wheels and the rear wheels.

Typically, the contact load distribution unit (32) is configured to set a front wheel distribution ratio of the front wheel target ground contact load between the left front wheel and the right front wheel, and a rear wheel distribution ratio of the rear wheel target ground contact load between the left rear wheel and the right rear wheel, according to the direction and the magnitude of the fore and aft acceleration and/or the direction and the magnitude of the lateral acceleration, and to compute the target ground contact load of the left front wheel and the target ground contact load of the right front wheel according to the front wheel target ground contact load and the front wheel distribution ratio, and the target ground contact load of the left rear wheel and the target ground contact load of the right rear wheel according to the rear wheel target ground contact load and the rear wheel distribution ratio.

Thereby, a difference may be created between the ground contact loads of the right and left wheels of the vehicle so that a corresponding difference is created in the fore and aft forces acting on the right and left wheels. As a result, a corresponding yaw moment is applied to the vehicle. By suitably selecting the magnitude of the yaw moment, the understeer tendency or the oversteer tendency of the vehicle can be controlled as desired.

Preferably, the front wheels are drive wheels, and when the vehicle is accelerating while turning a curve, the contact load distribution unit (32) is configured to set the target ground contact load of the front wheel on an outer side of the curve to be greater than the target ground contact load of the front wheel on an inner side of the curve.

Thereby, the fore and aft acceleration of the front wheel on the outer side of the curve can be made greater than the fore and aft acceleration of the front wheel on the inner side of the curve so that the yaw moment in the same direction as the turning direction of the vehicle can be increased. As a result, the understeer tendency that tends to occur when the vehicle is accelerating while turning a curve can be favorably suppressed.

Preferably, the front wheels are drive wheels, and when the vehicle is decelerating while turning a curve, the contact load distribution unit (32) is configured to set the target ground contact load of the front wheel on an inner side of the curve to be greater than the target ground contact load of the front wheel on an outer side of the curve.

Thereby, the fore and aft acceleration of the front wheel on the inner side of the curve can be made greater than the fore and aft acceleration of the front wheel on the outer side of the curve so that the yaw moment in the same direction as the turning direction of the vehicle can be decreased. As a result, the oversteer tendency (tuck-in) that tends to occur when the vehicle is decelerating while turning a curve can be favorably suppressed.

In such cases, preferably, the contact load distribution unit (32) is configured to increase a difference between the target ground contact loads of the left and right front wheels with an increase in the fore and aft acceleration and/or the lateral acceleration, or the fore and aft deceleration and/or the lateral deceleration.

Thereby, the magnitude of the yaw moment created by the difference between the ground contact loads of the right and left front wheels can be increased with an increase in the fore and aft acceleration and/or the lateral acceleration, or the fore and aft deceleration and/or the lateral deceleration.

Preferably, the front wheels are drive wheels, and when the vehicle is accelerating while turning a curve, the contact load distribution unit (32) is configured to set the target ground contact load of the rear wheel on an inner side of the curve to be greater than the ground contact load of the rear wheel on an outer side of the curve.

Thereby, the fore and aft acceleration of the rear wheel on the inner side of the curve can be made smaller than the fore and aft acceleration of the front wheel on the outer side of the curve so that the yaw moment in the same direction as the turning direction of the vehicle can be increased. As a result, the understeer tendency that tends to occur when the vehicle is accelerating while turning a curve can be favorably suppressed.

Preferably, the front wheels are drive wheels, and when the vehicle is decelerating while turning a curve, the contact load distribution unit (32) is configured to set the target ground contact load of the rear wheel on an outer side of the curve to be greater than the ground contact load of the rear wheel on an inner side of the curve.

Thereby, the fore and aft acceleration of the rear wheel on the outer side of the curve can be made smaller than the fore and aft acceleration of the front wheel on the outer side of the curve so that the yaw moment in the same direction as the turning direction of the vehicle can be increased. As a result, the oversteer tendency (tuck-in) that tends to occur when the vehicle is decelerating while turning a curve can be favorably suppressed.

In such cases, preferably, the contact load distribution unit (32) is configured to increase a difference between the target ground contact loads of the left and right rear wheels with an increase in the fore and aft acceleration and/or the lateral acceleration, or the fore and aft deceleration and/or the lateral deceleration.

Thereby, the magnitude of the yaw moment created by the difference between the ground contact loads of the right and left rear wheels can be increased with an increase in the fore and aft acceleration and/or the lateral acceleration, or the fore and aft deceleration and/or the lateral deceleration.

The present invention also provides a suspension control system (20) for a vehicle having left and right front wheels (2fl, 2fr) and a pair of rear wheels (2rl, 2rr), comprising: a variable damper (6fl, 6fr) provided between a vehicle body and each of the left front wheel (2fl) and the right front wheel (2fr); a ground contact load computation unit (31) configured to compute a front wheel target ground contact load according to a fore and aft acceleration of the vehicle body; a contact load distribution unit (32) configured to compute target ground contact loads of the left and right front wheels by varying a distribution of the front wheel target ground contact load between the left front wheel and the right front wheel according to a direction and a magnitude of the fore and aft acceleration and/or a direction and a magnitude of a lateral acceleration of the vehicle body; and a damping force computation unit (33) configured to set a target damping force of each variable damper according to the target ground contact loads of the front wheels.

Thus, the present invention provides a suspension control system that can suppress the pitching motion of the vehicle while suppressing an understeer and an oversteer tendency during cornering.

### BRIEF DESCRIPTION OF THE DRAWING(S)

FIG. 1 is a schematic diagram of a vehicle provided with a suspension control system according to an embodiment of the present invention;

FIG. 2 is a block diagram of the suspension control system;

FIG. 3 is a diagram illustrating the strategy for distributing the vehicle load between the front wheels and the rear wheels according to the embodiment of the present invention;

FIG. 4 is an electric current map showing the change in a stroke speed in relation to a target damping force and a target electric current value;

FIG. 5 is a graph showing the changes in a throttle opening angle, a lateral acceleration, and a yaw rate of the vehicle with time in a vehicle according to the present embodiment and a vehicle given here as an example for comparison; and

FIG. 6 is a schematic diagram illustrating the behavior of the vehicle during cornering according to the embodiment and the vehicle of the example for comparison.

### DESCRIPTION OF THE PREFERRED EMBODIMENT(S) OF THE INVENTION

A four-wheeled vehicle V incorporated with a suspension control system 20 according to an embodiment of the present invention is described in the following with reference to the appended drawings. In the drawings, the reference numerals for the four wheels 2 and the various components associated with each wheel 2 are appended with suffixes such as fl, fr, rl and rr to indicate to which of the four wheels 2 reference is being made. When such parts are collectively referred to, the suffixes may be omitted. The same rule applies to the wheel speed Vw.

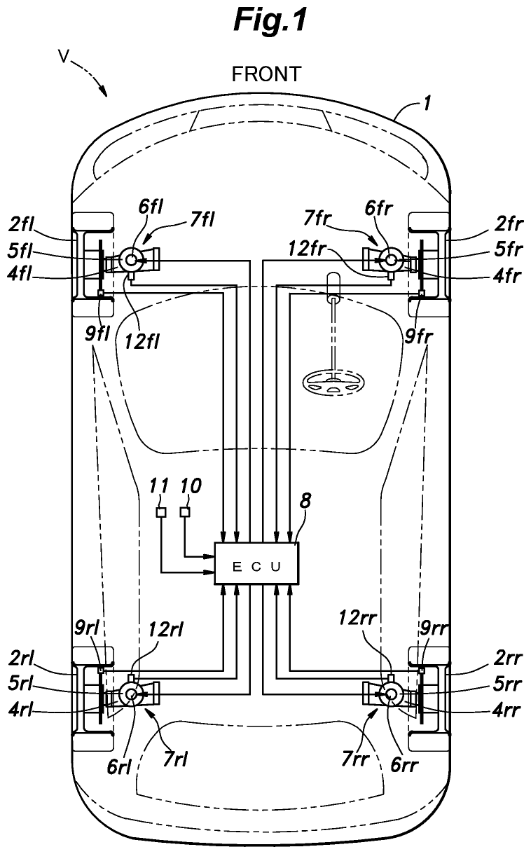

As shown in FIG. 1, the wheels 2 are installed on the vehicle body 1 of the vehicle V in a rectangular formation, and each of these wheels 2 is supported by the vehicle body via a suspension device 7 including a suspension arm 4, a spring 5, a variable damper (hereinafter simply referred to as a damper 6). The vehicle V in this case consists of an FF vehicle whose front wheels 2fl and 2fr are driven. In the following description, since the suspension devices 7 of the different wheels 2 are mostly identical to one another in terms of basic construction, only one of the wheels 2 and the associated parts may be discussed, instead of repeating the essentially same description to avoid redundancy.

The vehicle V is provided with an ECU 8 (Electronic Control Unit) providing various control functions, wheel speed sensors 9 for detecting the wheel speeds Vw of the respective wheels 2, stroke sensors 12 for detecting the strokes (stroke positions Sp) of the respective dampers 6, and various sensors mounted on the vehicle body such as a fore and aft acceleration sensor 10 for detecting the fore and aft acceleration Gx of the vehicle body, and a lateral acceleration sensor 11 for detecting the lateral acceleration Gy of the vehicle body. The vehicle may also be provided with a yaw rate sensor for detecting the yaw rate of the vehicle body 1, a steering angle sensor for detecting a steering angle, a brake pressure sensor for detecting a brake fluid pressure of a brake device, a torque sensor for detecting a driving torque of the drive wheels, and a transmission gear position sensor for detecting the gear position of a transmission device.

The ECU 8 comprises a microcomputer, ROM, RAM, peripheral circuits, input/output interface, various drivers, etc., and is connected to the dampers 6 of the respective wheels 2 and the respective sensors 9 to 12 via communication lines such as CAN.

The damper 6 may consist of any per se known variable damping force damper that can change the damping force according to an electrical signal received from the ECU 8. The damper 6 may, for instance, consist of an MR damper that uses a magnetorheological fluid (MRF) for the damping fluid, and is provided with a pair of chambers communicated with each other via a communication passage (orifice) fitted with a coil for selectively creating a magnetic field in the communication passage. Alternatively, the damper may have a communication passage whose cross sectional area can be varied by an input signal applied to a suitable device provided in the communication passage. In the MR dampers used in the present embodiment, when electric current is supplied to the coil under the control of the ECU 8, the resulting magnetic field causes the ferromagnetic particles in the MRF to form chain clusters so that the effective viscosity of the MRG increases. The damper 6 includes a cylinder having a lower end connected to the suspension arm 4 which may be considered as a wheel side member, and a piston rod having an upper end connected to a damper base (an upper part of the wheel house) which may be considered as a vehicle body side member.

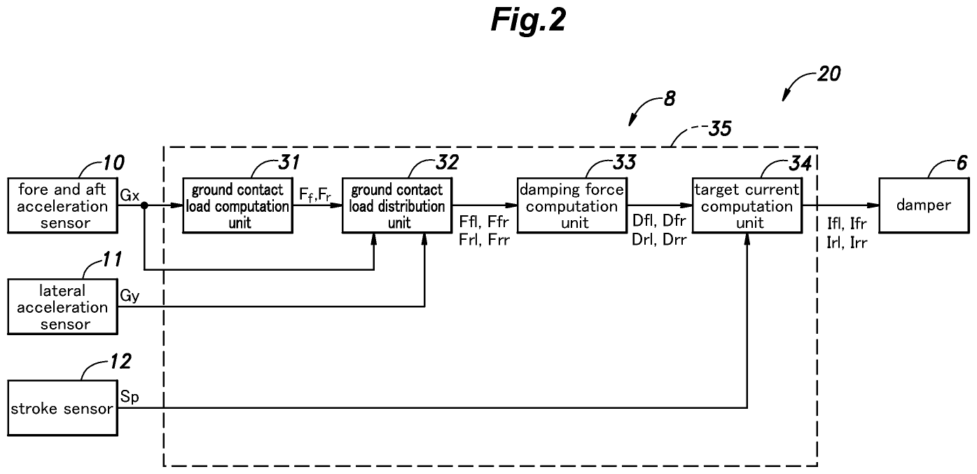

As shown in FIG. 2, the ECU 8 includes a pitch control unit 35 having a ground contact load computation unit 31, a ground contact load distribution unit 32, a damping force computation unit 33, and a target current computation unit 34.

The ground contact load computation unit 31 computes a front wheel target ground contact load Ff, which is a sum of the target ground contact loads of the left and right front wheels 2fl and 2fr, and a rear wheel ground contact load Fr, which is a sum of the target ground contact loads of the left and right rear wheels 2rl and 2rr, according to the fore and aft acceleration Gx detected by the fore and aft acceleration sensor 10. This process can be performed in a number of different ways. In the present embodiment, the ground contact load computation unit 31 computes the front wheel target ground contact load Ff by multiplying a front wheel gain G1 to a fore and aft acceleration differential value Gx′ obtained by differentiating the fore and aft acceleration Gx, and computes the rear wheel target ground contact load Fr by multiplying a rear wheel gain G2 to the fore and aft acceleration differential value Gx′ obtained by differentiating the fore and aft acceleration Gx.

The ground contact load distribution unit 32 computes the target ground contact loads Ffl, Ffr of the left and right front wheels 2fl and 2fr by varying the distribution of the front wheel target ground contact load Ff between the left and right front wheels 2fl and 2fr, and computes the target ground contact loads Frl, Frr of the left and right rear wheels by varying the distribution of the rear wheel ground contact load Fr between the left and right rear wheels 2rl and 2rr, based on the direction and the magnitude of the fore and aft acceleration Gx and the direction and the magnitude of the lateral acceleration Gy.

In the present embodiment, the ground contact load distribution unit 32 sets a front wheel distribution ratio Rf and a rear wheel distribution ratio Rr by referring to a preset map based on the direction and the magnitude (absolute value) of the fore and aft acceleration Gx and the direction and the magnitude (absolute value) of the lateral acceleration Gy. The front wheel distribution ratio Rf is a distributing ratio of the front wheel target ground contact load Ff to the left front wheel 2fl, and may range from 0 to 1. The rear wheel distribution ratio Rr is a distributing ratio of the rear wheel target ground contact load Fr to the left rear wheel 2rl, and may range from 0 to 1. The target ground contact loads of the wheels 2 are set according to the following formulas (1) to (4).

Ffl=Ff×Rf (1)

Ffr=Ff×(1−Rf) (2)

Frl=Fr×Rr (3)

Frr=Fr×(1−Rr) (4)

The sum of the left front wheel target ground contact load Ffl and the right front wheel target ground contact load Ffr is equal to the front wheel target ground contact load Ff (Ffl+Ffr=Ff), and the sum of the left rear wheel target ground contact load Frl and the right rear wheel target ground contact load Frr is equal to the rear wheel target ground contact load Fr (Frl+Frr=Fr).

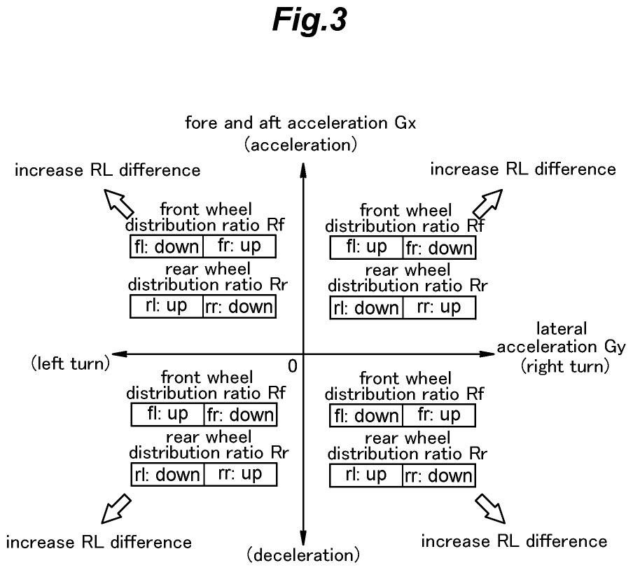

The distribution ratio map for setting the front wheel distribution ratio Rf and the rear wheel distribution ratio Rr is created based on the concept or the strategy illustrated in FIG. 3. In the distribution ratio map, when the vehicle is traveling in a curve, and the direction of the fore and aft acceleration Gx is on the acceleration side, the front wheel distribution ratio Rf is set such that the target ground contact load of the front wheel 2f on the outer side of the curve is greater than the target ground contact load of the front wheel 2f on the inner side of the curve, and the rear wheel distribution ratio Rr is set such that the target ground contact load of the rear wheel 2r on the inner side of the curve is greater than the target ground contact load of the rear wheel 2r on the outer side of the curve. In the distribution ratio map, conversely, when the vehicle is traveling in a curve, and the direction of the fore and aft acceleration Gx is on the deceleration side, the front wheel distribution ratio Rf is set such that the target ground contact load of the front wheel 2f on the inner side of the curve is greater than the target ground contact load of the front wheel 2f on the outer side of the curve, and the rear wheel distribution ratio Rr is set such that the target ground contact load of the rear wheel 2r on the outer side of the curve is greater than the target ground contact load of the rear wheel 2r on the inner side of the curve. When at least one of the fore and aft acceleration Gx and the lateral acceleration Gy is zero, the front wheel distribution ratio Rf and the rear wheel distribution ratio Rr are both set to 0.5. As a result, the left front wheel target ground contact load Ffl and the right front wheel target ground contact load Ffr are equal to each other, and the left rear wheel target ground contact load Frl and the right rear wheel target ground contact load Frr are equal to each other.

In this map, the front wheel distribution ratio Rf is set so that the difference between the target ground contact loads of the left and right front wheels 2fl and 2fr increases as the fore and aft acceleration Gx or the lateral acceleration Gy increases. The rear wheel distribution ratio Rr is set so that the difference between the target ground contact loads of the left and right rear wheels 2rl and 2rr increases as the fore and aft acceleration Gx or the lateral acceleration Gy increases. In other words, as the fore and aft acceleration Gx or the lateral acceleration Gy increases, the front wheel distribution ratio Rf and the rear wheel distribution ratio Rr are set to approach 0 or 1 from 0.5.

For example, the map may be defined in such a manner that, when accelerating and turning right, the front wheel distribution ratio Rf is set to be greater than 0.5 and less than or equal to 1 (excluding 0.5), and the front wheel distribution ratio Rf approaches 1 as the fore and aft acceleration Gx or the lateral acceleration Gy increases. Further, the rear wheel distribution ratio Rr may be set to a value in a range from 0 to 0.5, and the rear wheel distribution ratio Rr is set to approach 0 as the fore and aft acceleration Gx or the lateral acceleration Gy increases.

The damping force computation unit 33 computes the target damping forces Dfl, Dfr, Drl, Drr of the dampers 6 corresponding to the respective wheels 2 based on the target ground contact loads Ffl, Ffr, Frl, Frr of the respective wheels 2. The target damping forces Dfl, Dfr, Drl, Drr of the respective dampers 6 are computed, for example, by multiplying the target ground contact loads Ffl, Ffr, Frl, Frr of the corresponding wheels 2 by a predetermined gain G3 (Dfl=Ffl×G3, Dfr=Ffr×G3, Drl=Frl×G3, Drr=Frr×G3). Thus, the target damping force is set to be larger, or the dampers 6 are made stiffer as the target ground contact load increases.

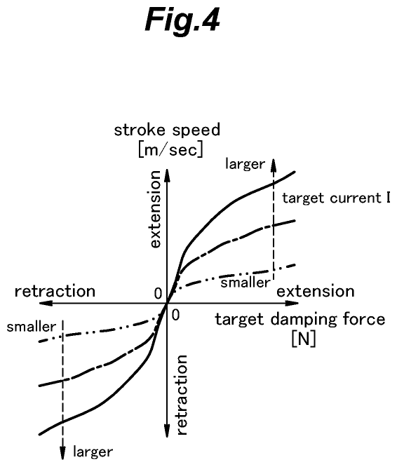

The target current computation unit 34 sets the target current Ifl, Ifr, Irl, Irr for each damper 6 based on the target damping force D and the stroke speed Sv. The stroke speed Sv for each damper 6 is obtained by differentiating the stroke position Sp detected by the corresponding stroke sensor 12 with time. The target current computation unit 34 sets the target current I based on the target damping force D and the stroke speed Sv corresponding to each damper 6 with reference to, for example, an electric current map shown in FIG. 4. Each damper 6 generates a damping force corresponding to the target electric current supplied thereto.

The mode of operation of the suspension control system 20 of the present embodiment is described in the following. In the pitch control of the dampers 6, the suspension control system 20 creates a difference in the ground contact load between the left front wheel 2fl and the right front wheel 2fr based on the fore and aft acceleration Gx and the lateral acceleration Gy. The resulting difference in the fore and aft force between the left front wheel 2fl and the right front wheel 2fr creates a yaw moment.

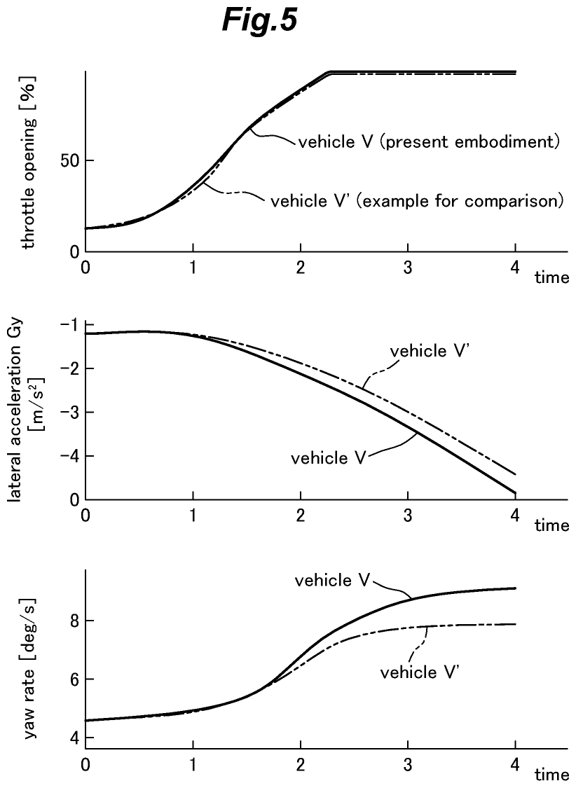

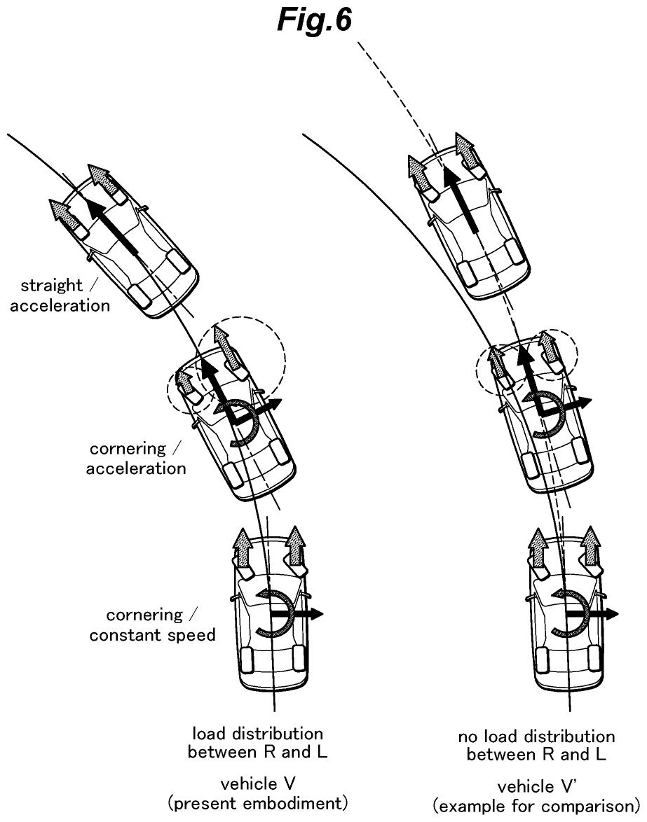

FIGS. 5 and 6 show the behavior of a vehicle making a transition from a first state where the vehicle makes a left turn at a constant speed and at a constant front wheel steering angle to a second state where the vehicle accelerates while maintaining the front wheel steering angle for each of a vehicle V according to the present embodiment and a vehicle V′ given as an example for comparison. The vehicle V′ of the example for comparison differs from the vehicle V of the present embodiment in the way the ground contact load is distributed between the left wheel and the right wheel, but is otherwise similar to the vehicle V of the present embodiment. In the vehicle V′ of the example for comparison, the front wheel distribution ratio Rf and the rear wheel distribution ratio Rr are both set to the value of 0.5. In other words, in the vehicle V′ of the example for comparison, Ffl=Ffr=Ff/2, and Frl=Frr=Fr/2.

In the first state where the vehicle is making a left turn at a constant speed with the steering angle of the front wheels 2fl and 2fr fixed at a constant value, since the fore and aft acceleration Gx is 0, the front wheel distribution ratio Rf and the rear wheel distribution ratio Rr are set to 0.5 in each of the vehicle V of the present embodiment and the vehicle V′ of the example for comparison. Thus, the two vehicles V and V′ behave in the same way in the first state.

When the vehicle starts accelerating and the makes a transition from the first state to the second state, in the case of the vehicle V of the present embodiment, the ground contact load distribution unit 32 refers to the distribution ratio map based on the fore and aft acceleration Gx and the lateral acceleration Gy, and sets the front wheel distribution ratio Rf and the rear wheel distribution ratio Rr accordingly. In particular, when the vehicle is accelerating in a leftward turn, the front wheel distribution ratio Rf is set to a value greater than or equal to 0 and less than 0.5, and the rear wheel distribution ratio Rr is set to a value greater than 0.5 and less than or equal to 1. Thus, the left front wheel target ground contact load Ffl is set smaller than the right front wheel target ground contact load Ffr, and the left rear wheel target ground contact load Frl is set greater than the right rear wheel target ground contact load Fm As a result, the friction circle of the right front wheel 2fr becomes larger than the friction circle of the left front wheel 2fl so that the forward fore and aft force of the right front wheel 2fr becomes larger than the forward fore and aft force of the left front wheel 2fl. Owing to the difference between the fore and aft force of the right front wheel 2fr and the fore and aft force of the left front wheel 2fl, a counterclockwise yaw moment is created, and the vehicle V is enabled to turn along a steady circle. As the right rear wheel target ground contact load Frr becomes smaller than the left rear wheel target ground contact load Frl, the load of the vehicle V is preferentially distributed to the right front wheel 2fr so that the right front wheel target ground contact load Ffr can be increased.

On the other hand, in the vehicle V′ of the example for comparison, the front wheel distribution ratio Rf and the rear wheel distribution ratio Rr are fixed at 0.5 even in the second state, regardless of the fore and aft acceleration Gx and the lateral acceleration Gy. Therefore, in both the first state and the second state, the left front wheel target ground contact load Ffl and the right front wheel target ground contact load Ffr are equal to each other, and the left rear wheel target ground contact load Frl and the right rear wheel target ground contact load Frr are equal to each other. Therefore, the vehicle V′ of the example for comparison demonstrates a smaller yaw rate and a smaller lateral acceleration compared to the vehicle V of the present embodiment, so that an understeer tendency tends to be demonstrated in the vehicle V′ of the example for comparison.

As discussed above, in the vehicle V of the present embodiment, when accelerating and cornering at the same time, the fore and aft force of the front wheel 2fl, 2fr on the outer side of the curve is made greater than the fore and aft force of the front wheel 2fl, 2fr on the inner side of the curve, whereby a yaw moment directed in the same direction as the steering or turning direction can be created. This is effective in suppressing the understeer tendency that often occurs when the vehicle is accelerated while cornering. Further, by making the ground contact load of the rear wheel 2rl, 2rr on the outer side of the curve smaller than the ground contact load of the rear wheel 2rl, 2rr on the inner side of the curve, the ground contact load of the front wheel 2fl, 2fr on the outer side of the curve can be increased even further. Thereby, the yaw moment directed in the same direction as the steering direction can be increased even further.

In the vehicle V of the present embodiment, when decelerating and cornering at the same time, the fore and aft force of the front wheel 2fl, 2fr on the inner side of the curve is made greater than the fore and aft force of the front wheel 2fl, 2fr on the outer side of the curve, whereby a yaw moment directed in the opposite direction from the steering or turning direction can be created. This is effective in suppressing the oversteer (tuck-in) tendency that often occurs when the vehicle is decelerating while cornering. Further, by making the ground contact load of the rear wheel 2rl, 2rr on the outer side of the curve greater than the ground contact load of the rear wheel 2rl, 2rr on the inner side of the curve, the ground contact load of the front wheel 2fl, 2fr on the outer side of the curve can be decreased even further. Thereby, the yaw moment directed in the same direction as the steering direction can be decreased even further.

The ground contact load distribution unit 32 increases the difference between the left rear wheel target ground contact load Frl and the right rear wheel target ground contact load Frr as the absolute value of the fore and aft acceleration Gx and/or the absolute value of the lateral acceleration Gy increases. Thereby, the yaw rate created by the dampers 6 can be increased.

The present invention has been described in terms of a specific embodiment, but is not limited by such an embodiment, and can be modified in various ways without departing from the spirit of the present invention. For instance, the ground contact load distribution unit 32 may be configured to change only the front wheel distribution ratio Rf based on the fore and aft acceleration Gx and the lateral acceleration Gy while the rear wheel distribution ratio Rr is fixed at the fixed value of 0.5.

1. A suspension control system for a vehicle having left and right front wheels and left and right rear wheels, comprising:
a variable damper provided between a vehicle body and each of the left front wheel, the right front wheel, the left rear wheel and the right rear wheel;
a ground contact load computation unit configured to compute a front wheel target ground contact load and a rear wheel target ground contact load according to a fore and aft acceleration of the vehicle body;
a contact load distribution unit configured to compute target ground contact loads of the left and right front wheels by varying a distribution of the front wheel target ground contact load between the left front wheel and the right front wheel, and to compute target ground contact loads of the left and right rear wheels by varying a distribution of the rear wheel target ground contact load between the left rear wheel and the right rear wheel, according to a direction and a magnitude of the fore and aft acceleration and/or a direction and a magnitude of a lateral acceleration of the vehicle body; and
a damping force computation unit configured to set a target damping force of each variable damper according to the target ground contact loads of the front wheels and the rear wheels.

2. The suspension control system according to claim 1, wherein the contact load distribution unit is configured to set a front wheel distribution ratio of the front wheel target ground contact load between the left front wheel and the right front wheel, and a rear wheel distribution ratio of the rear wheel target ground contact load between the left rear wheel and the right rear wheel, according to the direction and the magnitude of the fore and aft acceleration and/or the direction and the magnitude of the lateral acceleration, and
to compute the target ground contact load of the left front wheel and the target ground contact load of the right front wheel according to the front wheel target ground contact load and the front wheel distribution ratio, and the target ground contact load of the left rear wheel and the target ground contact load of the right rear wheel according to the rear wheel target ground contact load and the rear wheel distribution ratio.

3. The suspension control system according to claim 1, wherein the front wheels are drive wheels, and when the vehicle is accelerating while turning a curve, the contact load distribution unit is configured to set the target ground contact load of the front wheel on an outer side of the curve to be greater than the target ground contact load of the front wheel on an inner side of the curve.

4. The suspension control system according to claim 3, wherein the contact load distribution unit is configured to increase a difference between the target ground contact loads of the left and right front wheels with an increase in the fore and aft acceleration and/or the lateral acceleration.

5. The suspension control system according to claim 1, wherein the front wheels are drive wheels, and when the vehicle is decelerating while turning a curve, the contact load distribution unit is configured to set the target ground contact load of the front wheel on an inner side of the curve to be greater than the target ground contact load of the front wheel on an outer side of the curve.

6. The suspension control system according to claim 5, wherein the contact load distribution unit is configured to increase a difference between the target ground contact loads of the left and right front wheels with an increase in a fore and aft deceleration and/or a lateral deceleration.

7. The suspension control system according to claim 1, wherein the front wheels are drive wheels, and when the vehicle is accelerating while turning a curve, the contact load distribution unit is configured to set the target ground contact load of the rear wheel on an inner side of the curve to be greater than the ground contact load of the rear wheel on an outer side of the curve.

8. The suspension control system according to claim 7, wherein the contact load distribution unit is configured to increase a difference between the target ground contact loads of the left and right rear wheels with an increase in the fore and aft acceleration and/or the lateral acceleration.

9. The suspension control system according to claim 1, wherein the front wheels are drive wheels, and when the vehicle is decelerating while turning a curve, the contact load distribution unit is configured to set the target ground contact load of the rear wheel on an outer side of the curve to be greater than the ground contact load of the rear wheel on an inner side of the curve.

10. The suspension control system according to claim 9, wherein the contact load distribution unit is configured to increase a difference between the target ground contact loads of the left and right rear wheels with an increase in the fore and aft acceleration and/or the lateral acceleration.

11. A suspension control system for a vehicle having left and right front wheels and a pair of rear wheels, comprising:
a variable damper provided between a vehicle body and each of the left front wheel and the right front wheel;
a ground contact load computation unit configured to compute a front wheel target ground contact load according to a fore and aft acceleration of the vehicle body;
a contact load distribution unit configured to compute target ground contact loads of the left and right front wheels by varying a distribution of the front wheel target ground contact load between the left front wheel and the right front wheel according to a direction and a magnitude of the fore and aft acceleration and/or a direction and a magnitude of a lateral acceleration of the vehicle body; and
a damping force computation unit configured to set a target damping force of each variable damper according to the target ground contact loads of the front wheels.
